(19) United States
(12) Patent Application Publication
(10) Pub. No.: US 2009/0125388 A1
(43) Pub. Date: May 14, 2009

(54) PROCESS AND SYSTEM OF PERFORMING A SALES AND PROCESS AND SYSTEM OF IMPLEMENTING A SOFTWARE

(76) Inventor: Laercio Jose de Lucena Cosentino, Sao Paulo (BR)

Correspondence Address: FITCH EVEN TABIN AND FLANNERY, 120 SOUTH LASALLE STREET, SUITE 1600, CHICAGO, IL, 60603-3406, US

(21) Appl. No.: 11/937,575

(22) Filed: Nov. 9, 2007

(51) Int. Cl. G06Q 30/00

(52) U.S. Cl. 705/14

(57) ABSTRACT

The present invention refers to methods and systems to carry out a cycle of sales and the implementation of a software. According to a first aspect of the invention, the sales process comprises the steps of disclosing a product or service; carrying out a demonstration of said product or service; implementing or delivering said product or service to client; training client to use said product or service; and providing technical support to client in relation to said product or service; the disclosure step being carried out by electronic means, and the demonstration step is carried out remotely and in real time by a person having a participatory presence, allowing interaction between offerer and at least some of the prospects or clients, and in which the training, implementation and technical support steps are carried out by remote means.

### FIELD OF THE INVENTION

The present invention refers to methods and systems to carry out a sales cycle. More specifically, the present invention refers to methods and systems to carry out a sales cycle by which the sales cycles is carried out at least partially in a remote and/or automated form.

The present invention allows greater interaction between offers and prospects or sellers and clients, besides streamlining the sales cycle chain by using virtual means, such as the Internet, and/or automated means.

The present invention is particularly useful to carry out a sale of an intangible product, even if said intangible product can be transported or handled by physical means, such as a software, for example.

The present invention also teaches a process and a system for implementing a software.

### BACKGROUND OF THE INVENTION

A sales cycle is a succession of connected steps that occur with a view to sealing a deal for a certain product or service. It generally begins by a prospecting phase and, after concretizing the sale, it extends to the support and relationship with the client, or the so-called ‘post-sales’ phase.

Naturally, depending on the product or service to be commercialized, the cycle may comprise more or fewer specific phases needed for this or that product or service, by nature of the product or service offered, or by regulatory or legal impositions.

However, a conventional or generic sales cycle can be structured into distinct and well-defined phases, each one being necessary to seal the deal. In brief, this sales cycle is as follows:

The initial phase, generally occurring when there is a desire to generate new clients, is prospecting, which may be defined as an organized process to seek clients for the products or services offered. The prospecting phase may be substituted or overcome when instead of prospecting for a new client, a potential client seeks the offerer of a product or service, which it believes will satisfy its needs.

Jointly with the prospecting phase, or preceding it, marketing campaigns may be carried out in different media, such as television, the Internet, promotional catalogs etc. to disclose the product or service offered. Actions may be aimed at a specific public, both in relation to the media used and the trade dress, depending on the nature of the product or services placed on the market.

Having identified the client and its needs in the prospecting phase, then comes the approach or demonstration of the product or service offered. In the case of customizable products, this phase preferably also includes a presentation and/or demonstration formatted in accordance with the characteristics and needs of the prospect. It is desirable that the presentation be modeled according to the profile of the prospect. What is more, a participatory presence between the offerer and the prospect is desirable to help define and clearly align the problems and needs, to highlight the positive points of the product or service that might assist the prospect in solving his problem or meeting his need, and also to clarify any queries and to explain the technical or commercial aspects, without prejudice to other aspects.

Once these initial steps are over, then comes the business offer in which amounts, methods of payment, contract terms, technical characteristics of the product etc. are discussed. This is to say, the negotiation phase is primarily concerned with the commercial and technical aspects of the product or service.

Once the business aspects and sales terms for the product or service are finalized, then the contract is sealed or signed, after which the service will be rendered or the product will be delivered.

Particularly in relation to customizable products and services, delivery is not immediate. Performance of the service requires a certain amount of time at the client for implementation of the product. This phase is typically used when referring to software products, particularly softwares relating to business management. Such softwares often need to be adopted and tailored to adapt to the client's business and operational needs.

Still within this panorama is the training of the personal that will be qualified to become software users.

Lastly, the sales cycle having come to an end, is the post-sales phase, which can be synthetically defined as support and relationship with the client.

Naturally, and as stated above, the cycle now disclosed herein is a classic or conventional cycle. Depending on the nature and the characteristics of the product or service offered, there may be one or more steps, or even the elimination of certain phases.

The state of the art on this subject matter is vast. Particularly with the advent of the Internet in the 1990s, countless forms have been proposed, both in relation to systems as well as processes, to carry out sales using virtual and/or electronic means. These electronic and virtual processes of doing business have come to be known today as e-Business.

However, the state of the art to-date is deficient in the sense of providing a global solution for the sales cycle. In other words, the solutions found are focused on the virtualization and/or realization of electronic or automated processes for just one or some of the phases of the conventional sales cycle, as set forth above.

The solutions found have a series of weaknesses.

Firstly, concerning the prospecting phase, marketing actions over television, Internet (by sites accessed), physical media (such as catalogs) and physical media with digital content (such as promotional CDs and DVDs) etc. are known. These marketing actions, however, are often isolated, and there is no interaction with the prospect to develop the sales cycle chain.

When demonstrating to or approaching a client, there is also a limit in the state of the art in the sense that such demonstrations are static, that is, they are generally electronic files that the prospect can download and that contain pre-defined presentations or videos with a certain promotional message on the product or service offered. Accordingly, interaction is limited or non-existent.

This is prejudicial in the sense that specific queries the client has cannot be immediately answered. Additionally, there is a limitation in relation to other matters or personalized demonstrations that can be made to the prospect.

An attempt is made to redress this situation by providing standardized answers to frequently asked questions (FAQ) or service e-mails, by which specific answers may be sent.

Yet these attempts to resolve this inconvenience are still lacking, because in the first case, it is necessary to locate the desired answer from the many questions, causing a time delay, which is unpractical or unfriendly. In the second case, the answer to the question may take several days, causing a bad impression or disinterest by the prospect.

Furthermore, automated sales are extremely limited to products and/or services that are not customizable to the needs of the prospects, as is the case with finished products, such as DVDs, books, electronic products etc. In some products where a certain degree of customization is foreseen, this is generally limited to accessories or aesthetic characteristics, such as choice of color of the product.

In the case of products or services which have to be implanted or tailored at the client's facilities, after the deal has been finalized, it is not possible to identify a global solution in the state of the art that is associated to the other prior phases in the sales cycle, and in which implementation or tailoring is performed by remote means.

Additionally, although there are known e-learning solutions, that is, teaching and learning processes by remote means, there is equally no global solution that can be associated to the other steps of the sales cycle, at the point of implementation and training of a product at the client, by remote means.

Therefore, the objectives of the present invention are designed to overcome the inconveniences cited above. More particularly, the objective of the present invention is to add value to all the phases of the conventional sales cycle and, particularly, to the sales cycle of a customized product, such as a software, because it allows greater interaction between offerers and prospects, without prejudice to the virtualization and automation of sales processes.

Another objective of the present invention, besides providing greater interaction between offers and prospects, is that it allows the participation of other persons, in addition to those directly involved in the sales cycle, as a means of demonstrating the product or service offered as a means of disclosure and marketing.

Yet another objective of the present invention is to allow the convergence of technologies to carry out the sales cycle by way of different media.

### DESCRIPTION OF THE INVENTION

The objectives stated above, among others, are achieved by the present invention.

According to a first aspect, the present invention refers to a sales process that comprises the steps of:
disclosing a product or service;
carrying out a demonstration of said product or service;
implementing or delivering said product or service to client;
training the client to use said product or service; and
providing technical support to client in relation to said product or service; characterized in that the disclosure step is carried out by electronic means, and by the fact that the demonstration step is carried out remotely and in real time by a person having a participatory presence, allowing interaction between offerer and at least part of the prospects or clients, and by the fact that the training, implementation and technical support steps are carried out by remote means.

Without prejudice to visits to clients or prospects, which can be carried out according to convenience or demand of the prospects or clients, the process of the present invention allows the entire sales cycle to be carried out remotely and electronically.

One or more characteristics can also be present in the process of the present invention:

The prospecting step is eliminated.

The disclosure step of the product or service is carried out by marketing actions over the Internet.

The demonstration step is carried out by customized presentation for a specific prospect or client, such that the client can interact with the presenter.

The demonstration step is carried out by customized presentation for a specific prospect or client, such that the client can interact with the presenter, and persons other than the prospect or the client can also interact with the presenter.

The demonstration step is carried out by customized presentation for a specific prospect or client, such that the client can interact with the presenter, and persons other than the prospect can watch the presentation, without interaction with the presenter.

The demonstration step is preceded by a demonstration-scheduling step.

The implementation step or delivery of said product or service is preceded by a personal visit step to a prospect or client.

The implementation step or delivery of said product or service is preceded by a contract-sealing step by remote means using a digital signature.

The implementation step or delivery of said product of service to the client is carried out remotely over the Internet, with real time interaction between the parties.

The implementation step or delivery of said product of service to the client is carried out remotely over the Internet in real time without interaction between the parties.

The implementation step or delivery of said product of service to the client is carried out remotely over the Internet, with real time interaction between the parties and, concomitantly, in real time and without interaction by other participants.

There is a limited number of interactive accesses between the parties.

There is no limited number of non-interactive accesses between the parties.

The process steps are achieved by means of the Internet, Digital TV network, or cellular and/or telephone communication network.

Said product or service is a software.

The present invention also refers to a software implementation process by remote means that comprises the steps of:
carrying out a demonstration of the software;
implementing said software at the client;
training the client to use said software;
providing technical support to the client in relation to said software; characterized in that the demonstration step is carried out remotely and in real time by a person having a participatory presence, allowing interaction between the offerer and at least some of the persons that make up the prospect or client, and by the fact that the implementation and training steps are carried out by remote means, and by the fact that the technical support is carried out by remote means.

According to this second embodiment, the following characteristics may or may not be contained in the process of the present invention:

The demonstration step is by customized presentation for a specific prospect or client, such that said prospect or client can interact with the presenter.

The demonstration step is by customized presentation for a specific prospect or client, such that said prospect or client can interact with the presenter, and persons other than the prospect or client can also interact with the presenter.

The demonstration step is by customized presentation for a specific prospect or client, such that said prospect or client can interact with the presenter, and persons other than the prospect or client can watch the presentation, without interaction with the presenter.

The demonstration step is preceded by a demonstration-scheduling step.

The implementation step of the software is preceded by a personal visit to the client.

The implementation step of said software is preceded by a contract-sealing step by remote means using a digital signature.

The implementation step of said software is carried out remotely, with real time interaction between the parties.

The implementation step of said software is carried out remotely, without real time interaction between the parties.

The implementation step of said software is carried out remotely over the Internet, with real time interaction between the parties and, concomitantly, in real time but without interaction with other parties.

There are a limited number of interactive accesses between the parties.

There is no limited number of non-interactive accesses between the parties.

The process steps carried out remotely are achieved by means of the Internet, Digital TV network, or cellular and/or telephone communication network.

The present invention refers to systems for carrying out the processes of the present invention.

According to another aspect of the invention, the system for carrying out a sale comprises means at the offerer side to disclose an object remotely; means to make a presentation or demonstration of the object in real time and with participatory presence; means to implement or deliver the object also by remote means; means to carry out remote training; and means to provide client support by remote means, and comprises means at the side of the prospect to access a network for interaction with the offerer.

Said means may be any suitable means for the transmission of data by remote means over a network, such as computers, servers, PDAs or digital TV.

The network can be a data communication network, such as the Internet, a mobile telephony network or a Digital TV network having a return channel. Third parties can access the network, but without interactive participation.

Finally, the present invention refers to a software implementation system by remote means, which comprises means to carry out a demonstration of the software, in real time and with a participatory presence; means to deliver and implement the software; means to carry out remote training at the client; and means to provide client support by remote means.

Said means may be any suitable means for the transmission of data by remote means over a network, such as computers, servers, PDAs or digital TV, and connected to the network through a communication backbone.

The network can be a suitable data transmission network, such as the Internet, a mobile telephony network or a Digital TV network having a return channel, and the participants can access the network and participate interactively or merely as listeners.

### BRIEF DESCRIPTION OF THE DRAWINGS

The present invention will now be described in relation to a particular embodiment with reference to the attached drawings. Said drawings didactically represent the sales system and software implementation system, respectively, according to embodiments of the present invention.

### DESCRIPTION OF PARTICULAR EMBODIMENTS

The processes and systems of the present invention are useful for the optimized embodiment of the sales process and the software implementation process, by remote, interactive and/or automated means.

According to a first embodiment, the process starts by prospecting and/or marketing actions to disclose a certain product or service offered and the generation of clients, respectively.

In order to facilitate the description, both the term ‘products’ and the term services' will be referred to as “objects”.

Prospecting actions can be accompanied by marketing actions, simultaneously or successively. Thus, in this present specification, prospecting shall be understood to be a coordinated action to generate clients, said coordinated action being accompanied by marketing actions and disclosure of the object or not.

The initial step of prospecting, according to the process of the invention, is carried out by electronic or remote means.

By electronic or remote means shall also be understood to be an action unleashed without the physical presence of a person at the place of action, that is, it can be carried out remotely, and where the physical presence or the use of physical products for the action to be carried out is not necessary.

These electronic means are primarily actions focused on the Internet, by means of specific sites, or by a convergence of media through other networks, such as by PDAs (Personal Digital Assistant) in cellular telephone networks, or also on digital TV networks that have a return channel that permits interaction in a Digital TV environment.

The action of prospecting can be different depending on the nature of the object and the target public of such object. Therefore, prospecting in itself is not relevant for the scope of the present invention, provided that it is carried out by remote and electronic means.

Naturally, other non-electronic or remote means can be used for a prospecting step, provided that at least part of the prospecting step is carried out by remote and electronic means, such as defined above.

The prospecting step can be eliminated when the prospect is already a consolidated client or when the prospect itself seeks the offerer to acquire the desired object.

Next comes the presentation of the object to the prospect. The presentation, as it occurs today by remote means, such as over the Internet, for example, is generally by information contained on the own web site of the offerer of the object or by electronic files, such as Power Point presentations, promotional videos etc, that the prospect can access.

The presentations of objects in state of the art systems are not interactive or have limited interactivity, because the offerer is not physically present, which could, in real time and immediately, solve any queries the prospect may have in relation to the object, for example.

Moreover, the content of the forms of presentation of the objects by remote and electronic means, as found in the state of the art, is static in the sense that it does not allow customization to meet the needs or specific expectations of the prospect.

The present invention proposes that the presentation step of the object be carried out by remote means, but with participation by the offerer. Accordingly, the presentation may be customized for each prospect and allow real time interaction between prospect and offerer, besides not requiring that the offerer or prospect physically go to a specific presentation site.

Thus, the preliminary relationship between offerer and prospect is substantially improved by allowing greater interactivity between the parties, providing a presentation that is customized to the needs and expectations of the prospect, and avoiding any queries or subsequent discussions not be settled immediately, if it is not possible by conventional electronic means, as indicated above.

Other participants besides the offerer and prospects may be associated to this presentation step, with or without the possibility of interacting. Interaction may be by any suitable means, either by way of a personal computer using the Internet or with PDAs in a telephone network, or by television in the digital TV network having a return channel.

Since the participatory presentation may not be available full time, due to office hours, time zone differences, or availability of the presenter, a presentation scheduling step may precede this step, scheduled either by the offerer or by the prospects, in which a limited or unlimited number of interactive participants may be defined and/or a limited or unlimited number of listening participants, that is, not interactive, which may equally be defined.

If the prospect is interested in the object, negotiation and contract sealing steps may follow. Alternatively, according to an embodiment of the present invention, a contract sealing step can also be carried out remotely, by electronic means, using an electronic signature or also encryption means, both public switch and asymmetric.

After sealing the contract, if applicable, or after the object is accepted by the prospect, thus becoming a client, then the object is delivered or implemented.

In the case of non-customizable objects, that is, those that are generally characterized by finished products that cannot be modified or adapted to the desires or needs of clients, delivery only to the client is carried out by conventional means. Typically, said objects are books, DVDs, electronic apparatus etc, in which the client merely chooses the product he wants, but there is no alteration to the product itself.

If the object is a product that allows a certain degree of customization, such as, for example, the choice of color or product options, delivery is equally carried out by conventional means, after determining the model or characteristics of the product.

However, certain products and services require adaptation to the needs or wishes of clients or, also, products that are sold in association with services, which is typically the case of a software. Often a software, and particularly a software designed for business management, besides constituting a product to be delivered, is also associated with services of implementation, tailoring or, also, customization by way of specific programming, to meet and comply with the client's operating requirements.

Consequently, the product is not just delivered, but there is also an associated service so that the product performs its function adequately.

According to an embodiment of the present invention, in the case of a product with digital content, the delivery may be carried out remote means, by sending a file over a network, such as the Internet or a mobile telephone network or Digital TV.

Also according to the present invention, the implementation is carried out remotely, through a network connection between vendor and client. Particularly at this step, there may be interactive participation between vendor and client, and possibly also the interactive or non-interactive participation of one or more persons other than the client. This interactive or non-interactive participation (that is, participants are merely listeners) of the implementation step of a client can be used as a means of disclosure or demonstration of a real case to other prospects or clients. Put otherwise, it can be used as an instrument of marketing, disclosure and demonstration of the product in a real case of implementation at already consolidated clients for new prospects, or else as a means of training for other clients or business partners.

With implementation comes client training, which may occur simultaneously or after implementation. The present invention also provides for the remote training of the client, by way of a network, be it a telephone network, Digital TV or the Internet. In the same way as during the implementation step, the training step allows interaction between vendor and client, and also an interactive or non-interactive participation by persons other than the client, either as a marketing action or training.

After this cycle comes technical support and relationship with the client by way of post-sales action, that are preferably are carried out by remote means, such as, for example, chats over the Internet or call center, without excluding any others.

The present invention also discloses a software implementation process by remote means, as set forth in the description of the invention above.

The process according to this second aspect of the invention overcomes the steps that precede and follow the sales cycle of a software, and focuses solely on the demonstration, implementation, training and technical support for the client by remote means.

The process begins by the presentation and/or demonstration of the software product to the client, in which the presentation or demonstration is carried out by remote means, but with the participatory presence of the offerer. Therefore, and as shown above, it is possible that presentation and also the demonstration of the software product be customized for the client's needs and expectations. The fact that it is carried out in real time and with a participatory presence, albeit remote, of both the offerer and the client, allows the parties to interact.

Hence, this interactivity allows any queries or discussions that occur concomitantly or which arise after the presentation or demonstration to be settled and developed at the same time, substantially improving the relationship.

Associated to this step of presentation and/or demonstration of the product is the fact that other parties may participate in addition to the vendor and the client, said participants being able or unable to interact.

Interaction may be by any suitable means, either through personal computer using the Internet or PDAs in a telephone network or television in a digital TV network having a return channel.

Since the participatory presentation may not be available full time, due to office hours, time zone differences, or availability of the presenter, the presentation scheduling step may precede this step, scheduled either by the offerer or by the prospects, in which a limited or unlimited number of interactive participants may be defined and/or a limited or unlimited number of listening participants, that is, not interactive, which may equally be defined.

After the presentation and/or demonstration of the software product, implementation at the client follows, in which parameters will be defined to meet the specific requirements of each client. Implementation encompasses both the delivery of the digital content of the software that is carried out by remote means, by sending a file via a network, such as the Internet or a mobile telephone or digital TV network, as well as the implementation thereof, also by remote means, through a network connection between vendor and client. This step includes interactive participation between vendor and client and may also comprise interactive or non-interactive participation of one or more parties other than the client. This interactive or non-interactive participation (that is, participants being merely listeners) in the implementation step can be used as a form of disclosure or demonstration of a real case to other prospects or clients. Accordingly, it can be used as an instrument of marketing, disclosure and demonstration of the product of a real case in use at already consolidated clients for new prospects or else as a form of training for other clients or business partners.

With the implementation comes client training, which may occur simultaneously or after implementation. The present invention also allows the remote training of the client, also through a network, be it a telephone or digital TV network of the Internet. In the same way as during the implementation step, the training step allows interaction between vendor and client, and also an interactive or non-interactive participation by persons other than the client, either as a marketing action or training.

After the implementation and training steps comes the technical support and relationship with the client by way of post-sales action, that are preferably carried out by remote means, such as, for example, chats over the Internet or call center, without excluding any others.

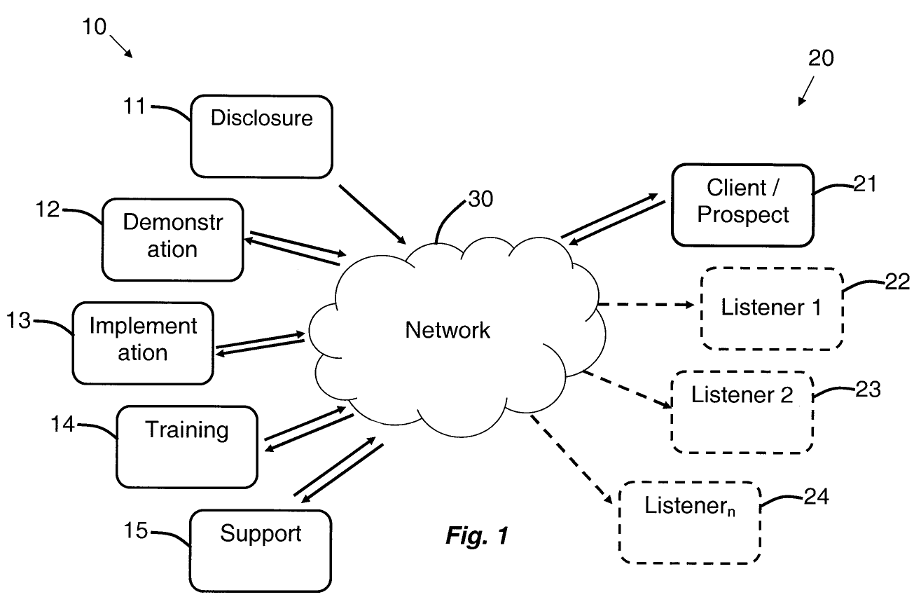

The invention also refers to a system for carrying out a sale, by remote means. FIG. 1 is a schematic representation of the system of the present invention. On the one hand is the offerer or vendor (10) of the object, in which the sale steps are unleashed, pursuant to the process already described and, on the other hand is the prospect (20) which may become a client and, in certain steps, there is real time interaction between offerer or client.

The system comprises, in relation to the offerer (10), means (11) to disclose an object remotely, means (12) to make a presentation or demonstration of the object, in real time and with a participatory presence, means (13) to implement or deliver the object also by remote means, means (14) to carry out remote training and means (15) to provide client support by remote means.

The means listed above may be any suitable means for the transmission of remote means over a network (30), such as computers, servers, PDAs or digital TV.

Said means may be connected to the network (30) by way of a communication backbone. The network (30), in turn, may be any suitable data transmission network, such as the Internet, a mobile telephony network or a Digital TV network having a return channel. Naturally, there may be interaction between one or more of these networks.

In relation to the prospect or client (20), some can participate interactively in the process of the present invention (21) and others only as listeners (22-24). Theoretically, there is no limit on the number of interactive participants (21) and listeners (22-24), which may be limited or unlimited depending on the specific aspects imposed by the offerer (10).

In the same way, both the prospect/client (21) as the others participating merely as listeners (22-24) must have means of access to a network interaction with the offerer (10) or merely to receive data provided by the offerer (10). Said means may be any suitable means for receiving and sending data by a communication network, such as, but not limited to, personal computers, PDAs, Digital TV etc.

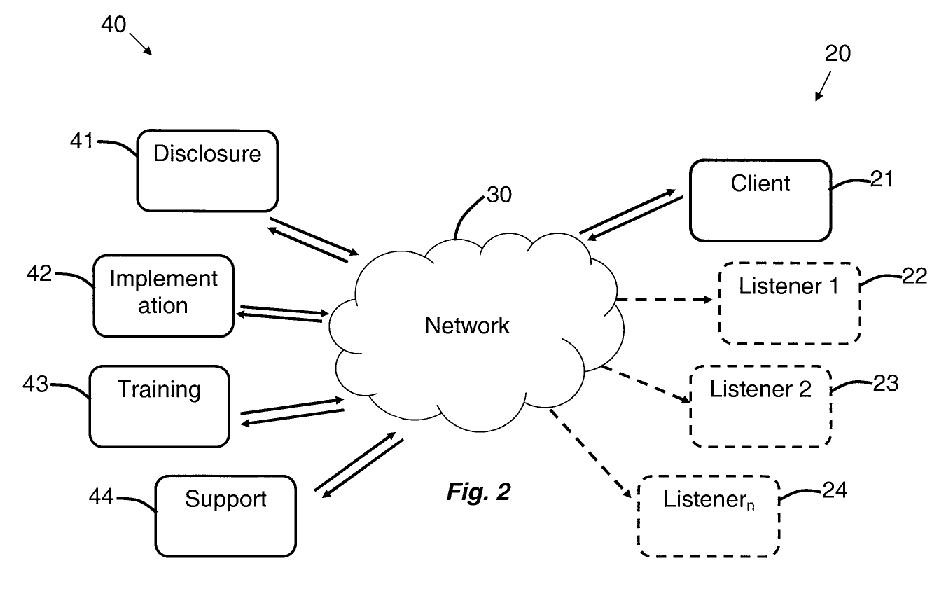

FIG. 2 represents a schematic illustration to carry out the software implementation process according to the second aspect of the present invention.

On the one hand, the system provides means (41) to carry out a demonstration of the software, in real time and with participatory presence, means (42) to deliver and implement the software, means to carry out remote training at the client, and means (44) to provide client support by remote means.

The means listed above may be any suitable means for the transmission of remote means over a network (30), such as computers, servers, PDAs or digital TV.

These means may be connected to the network (30) by way of a communication backbone. The network (30), in turn, may be any suitable data transmission network, such as the Internet, a mobile telephony network or a Digital TV network having a return channel. Naturally, there may be interaction between one or more of these networks.

In relation to the client (20), some can participate interactively in the process of the invention (21) and others merely as listeners (22-24), as stated above.

Further, there is no limit on the number of interactive participants (21) and listeners (22-24), which may be limited or unlimited depending on the specific aspects imposed by the vendor (40).

In the same way, both the client (21) and the others participating as listeners (22-24) must have means of access to a network to interact with the vendor (40), or just means to receive data provided by the offerer (40), depending on whether there is interaction or not. Such means may be any suitable means for receiving and sending data by way of a communication network, such as, but not limited to, personal computers, PDAs, Digital TV etc.

To improve interaction, other hardwares such as cameras, microphones etc. can also be used.

The present invention presents a series of advantages in relation to the processes and systems known in the state of the art because, firstly, it allows a global solution for the sales cycle by remote means, and also enables a effective participation and interaction between offerer or vendor and prospects or clients.

Moreover, the present invention allows a cost reduction in the disclosure and implementation of products and services, particularly in the disclosure and implementation of a software, because all the steps can be carried out by remote means and electronically, without the need for physical relocation of personnel, both for the offerer/vendor, and for the prospect/client.

What is more, there is the possibility of opening the processes of disclosure and implementation to third parties, who can participate interactively or merely as listeners, and also enables a greater disclosure and demonstration of cases of concrete use, leveraging marketing actions, sales and relationships with potential clients and already existing clients.

It must be recognized that although the present invention has been described in relation to its particular embodiments, persons skilled in the art may develop variations based on the teachings disclosed above. Therefore, the claims appended hereto should be interpreted as all-inclusive of all the equivalents contained within the breadth and scope of the present invention.

1. A sale process comprising steps of:
disclosing a product or service;
carrying out a demonstration of said product or service;
implementing or delivering said product or service to client;
training client to use said product or service; and
providing technical support to client in relation to said product or service;
wherein the disclosure step is carried out electronically,
the demonstration step is carried out remotely and in real time by a presenting person, allowing interaction between offerer and at least some of prospects or clients, and
the implementing, training, and technical support steps are carried out remotely.

2. (canceled)

3. The sale process according to claim 1, wherein the disclosure step of the product or service is carried out by marketing actions over the Internet.

4. The sale process according to claim 1, wherein the demonstration step is by customized presentation for a specific prospect or client, such that the client can interact with the presenting person.

5. The sale process according to claim 1, wherein the demonstration step is by customized presentation for a specific prospect or client, such that the client can interact with the presenting person, and parties other than the prospect or the client can also interact with the presenting person.

6. The sale process according to claim 1, wherein the demonstration step is by customized presentation for a specific prospect or client, such that the client can interact with the presenting person, and parties other than the prospect can watch the presentation, without interaction with the presenting person.

7. The sale process according to claim 1, comprising a demonstration-scheduling step preceding the demonstration step.

8. The sale process according to claim 1, comprising step of a personal visit to prospect or client preceding the implementing or delivering step.

9. The sale process according to claim 1, comprising a step of a contract-sealing by remote means using a digital signature preceding the implementing or delivering step.

10. The sale process according to claim 1, wherein the step of implementing or delivering is carried out remotely over the Internet, with real time interaction between parties.

11. The sale process according to claim 1, wherein the step of implementing is carried out remotely over the Internet in real time without interaction between parties.

12. The sale process according to claim 1, wherein the step of implementing is carried out remotely over the Internet, with real time interaction between parties and, concomitantly, in real time and without interaction by other participants.

13. The sale process according to claim 1, wherein there is a limited number of interactive accesses between parties.

14. The sale process according to claim 1, wherein there is an unlimited number of non-interactive accesses between parties.

15. The sale process according to claim 1, wherein the process steps are provided by means of the Internet, Digital TV network, or cellular and/or telephone communication network.

16. The sale process according to claim 1, wherein said product or service is a software.

17. Software implementation process by remote means comprising the steps of:
carrying out a demonstration of the software;
implementing said software at the client;
training the client to use said software;
providing technical support to the client in relation to said software;
wherein the demonstration step is carried out remotely and in real time by a presenting person, allowing interaction between offerer and at least some of prospects or clients, and
the implementing, training and technical support steps are carried out remotely.

18. Software implementation process according to claim 17, wherein the demonstration step is by customized presentation for a specific prospect or client, such that said prospect or client can interact with the presenting person.

19. Software implementation process according to claim 17, wherein the demonstration step is by customized presentation for a specific prospect or client, such that said prospect or client can interact with the presenting person, and parties other than the prospect or client can also interact with the presenting person.

20. Software implementation process according to claim 17, wherein the demonstration step is by customized presentation for a specific prospect or client, such that said prospect or client can interact with the presenting person, and parties other than the prospect or client can watch the presentation, without interaction with the presenting person.

21. Software implementation process according to claim 17, comprising a demonstration-scheduling step preceding the software demonstration step.

22. Software implementation process according to claim 17, comprising the step of a personal visit to the client preceding the software implementing step.

23. Software implementation process according to claim 17, comprising a step of a contract-sealing by remote means using a digital signature prior to the implementing step.

24. Software implementation process according to claim 17, wherein the software implementing step is carried out remotely, with real time interaction between parties.

25. Software implementation process according to claim 17, wherein the software implementing step is carried out remotely, without real time interaction between parties.

26. Software implementation process, according to claim 17, wherein the software implementing step is carried out remotely over the Internet, with real time interaction between parties and, concomitantly, in real time but without interaction with other parties.

27. Software implementation process, according to claim 17, wherein there is a limited number of interactive accesses between parties.

28. Software implementation process, according to claim 17, wherein there is an unlimited number of non-interactive accesses between the parties.

29. Software implementation process, according to claim 17, wherein the steps of the process carried out remotely are achieved by means of the Internet, Digital TV network, or cellular and/or telephone communication network.

30. A sale system comprising means to disclose an object remotely, means to make a presentation or demonstration of the object, in real time and with a participatory presence, means to implement or deliver the object also remotely, means to carry out remote training, means to provide remotely support for client means to access a network for interaction with the offerer.

31. The system according to claim 30, wherein said means include means for transmission over network comprising at least one of computers, servers, PDAs and digital TV.

32. The system according to claim 30, wherein said network is a data communication network comprising at least one of the Internet, a mobile telephony network and a Digital TV network having a return channel.

33. The system according to claim 30, wherein third parties can access the network, but without interactive participation.

34. The system according to claim 30, wherein there is unlimited number of interactive participants and listeners.

35. The system according to claim 30, wherein there is a limited number of interactive participants and listeners.

36. A software implementation system, comprising means to carry out a demonstration of the software, in real time and with a participatory presence, means to deliver and implement the software, means to carry out remote client training, and means to provide remote client support.

37. The system according to claim 36, wherein said means include means for transmission over network comprising at least one of computers, servers, PDAs and digital TV.

38. The system according to claim 36, wherein said means are connected to the network by way of a communication backbone.

39. The system according to claim 36, wherein the network is a suitable data transmission network comprising at least one of the Internet, a mobile telephony network and a Digital TV network having a return channel.

40. The system according to claim 36, wherein some participants may participate interactively and others only as listeners.

41. The system according to claim 36, wherein there is an unlimited number of interactive participants and listeners.

42. The system according to claim 36, wherein there is a limited number of interactive participants and listeners.

43. The system according to claim 33, wherein there is an unlimited number of interactive participants and listeners.

43. The system according to claim 33, wherein there is a limited number of interactive participants and listeners.

45. The system according to claim 40, wherein there is an unlimited number of interactive participants and listeners.

46. The system according to claim 40, wherein there is a limited number of interactive participants and listeners.
